(19) United States
(12) Patent Application Publication
(10) Pub. No.: US 2005/0268504 A1
(43) Pub. Date: Dec. 8, 2005

(54) Designer object holders

(76) Inventor: Ruby H. Haskins, Old Bridge, NJ (US)

Correspondence Address: Mr. Walter J. Tencza Jr., Suite 3, 10 Station Place, Metuchen, NJ, 08840, US

(21) Appl. No.: 10/862,720

(22) Filed: Jun. 7, 2004

(51) Int. Cl. G09F 3/00

(52) U.S. Cl. 40/306

(57) ABSTRACT

A container is disclosed including a body portion and a lid. A first towel is typically wrapped around the body portion. The first towel may include a design. A second towel may be attached to the lid. The second towel may also include a design. At least one three dimensional object may be attached to the first towel and to the second towel. The body portion of the container may have a cylindrical shape. A method is also disclosed comprising placing a first design on a first towel, and attaching the first towel to a body portion of a container. The method may also include placing the first design on the first towel by ironing the first design onto the first towel.

### FIELD OF THE INVENTION

This invention relates to improved methods and apparatus concerning containers that hold objects.

### BACKGROUND OF THE INVENTION

Typically in the prior art objects may be held in various types of containers.

### SUMMARY OF THE INVENTION

The present invention in one or more embodiments provides an apparatus comprising a container comprised of a body portion and a lid. A first towel is typically wrapped around the body portion. The first towel may include a design. A second towel may be attached to the lid. The second towel may also include a design. At least one three dimensional object may be attached to the first towel and to the second towel. The body portion of the container may have a cylindrical shape. First and second fabrics, such as suede fabrics or other fabrics may be substituted for the first and second towels.

The present invention in one or more embodiments also provides a method comprising the steps of placing a first design on a first towel, and attaching the first towel to a body portion of a container. The method may also include placing the first design on the first towel by ironing the first design onto the first towel. The method may also include attaching at least one three dimensional object to the first towel. The method may also include placing a second design on a second towel; and attaching the second towel to a lid of the container.

### BRIEF DESCRIPTION OF THE DRAWINGS

FIG. 1A shows a top perspective view of an apparatus, including a body portion and a lid, in accordance with a first embodiment of the present invention;

FIG. 1B shows a bottom perspective view of the lid of the apparatus of FIG. 1A;

FIG. 1C shows a top perspective view of the apparatus of FIG. 1A in a closed state;

FIG. 2A shows a top view first and second towels for use with an embodiment of the present invention;

FIG. 2B shows a top view of first and second templates for use with an embodiment of the present invention;

FIG. 2C shows a top view of the first and second towels of FIG. 2A after first and second designs, respectively, have been transferred onto the first and second towels;

FIG. 3 shows a top view of the first and second towels with the respective designs and further including one or more three dimensional objects mounted on the first and second towels; and

FIG. 4 shows a perspective view of the apparatus of FIG. 1A with the first towel attached to the body portion of the apparatus and the second towel attached to the lid of the apparatus.

### DETAILED DESCRIPTION OF THE DRAWINGS

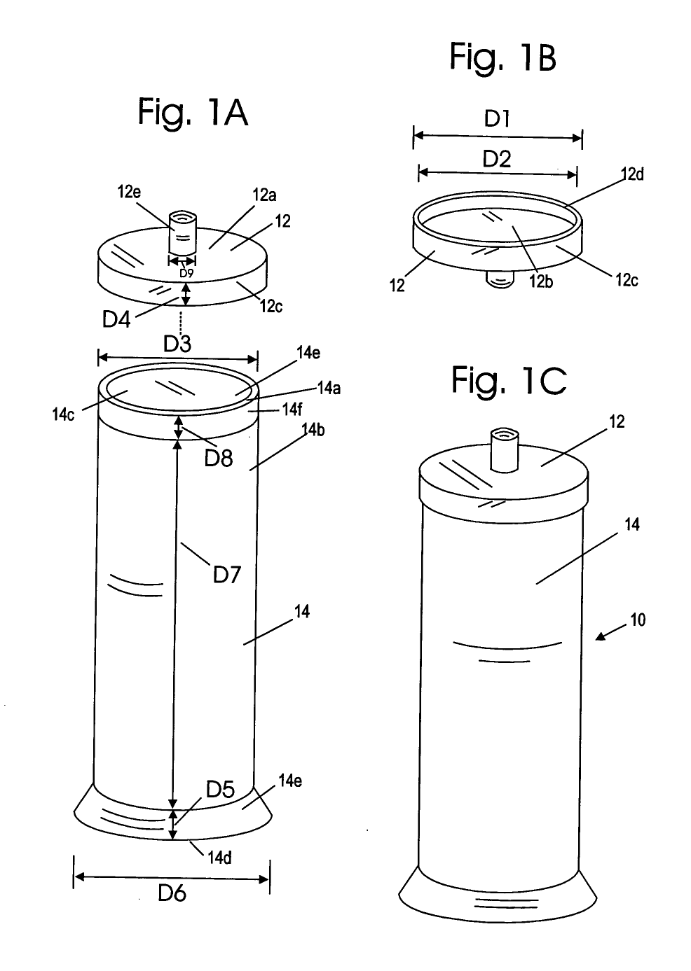

FIG. 1A shows a top perspective view of an apparatus 10 in an open state, including a body portion 14 and a lid 12, in accordance with a first embodiment of the present invention. FIG. 1B shows a bottom perspective view of the lid 12 of the apparatus 10 of FIG. 1A. FIG. 1C shows a top perspective view of the apparatus 10 in a closed state.

The lid 12 includes a top surface 12a, a bottom surface 12b, and a side or perimeter 12c having a bottom edge 12d. The top surface 12a may be circular shaped and may have a diameter of D1, which may be 5 inches. The bottom surface 12b may be circular shaped and have a diameter of D2, which may be slightly less than the diameter D1. The body portion 14 may include the edge 14a, the portion 14b, a top opening 14c, and a closed bottom 14d. There may be a portion 14e which gradually increases in slope from the portion 14b to the bottom 14d. The portion 14e may be D5 inches long which may be two and ½ inches. The portion 14b or body portion may be D7 inches long which may be sixteen and 1/6 inches. There may be a portion 14f over which the lid 12 fits. Portion 14f may be D8 inches in depth which may be one and one half inches. The diameter D2 typically allows the lid 12 to fit on top of the body portion 14 so that the perimeter 12c overlaps portion 14b of the body portion or container 14 and so that the bottom surface 12b of the lid 12 comes in contact with an edge 14a of the body portion. FIG. 1C shows the lid 12 placed over the opening 14c of the body portion 14 so that the apparatus or container 10 is closed. With the apparatus 10 closed, there is a chamber 14e which is bound by the bottom surface 12b of the lid 12, the portion 14b of the body portion 14, and the closed bottom 14d of the body portion 14. The body portion 14 may have a cylindrical shape.

The lid 12 may have a depth of D4, which may be two inches. The lid 12 may have a knob 12e, which may be centrally located which may have a diameter of one inch. The lid 12 may have a height of five and one half inches rising above the surface 12a. The bottom 14d may have a diameter of D6 which may be nineteen inches.

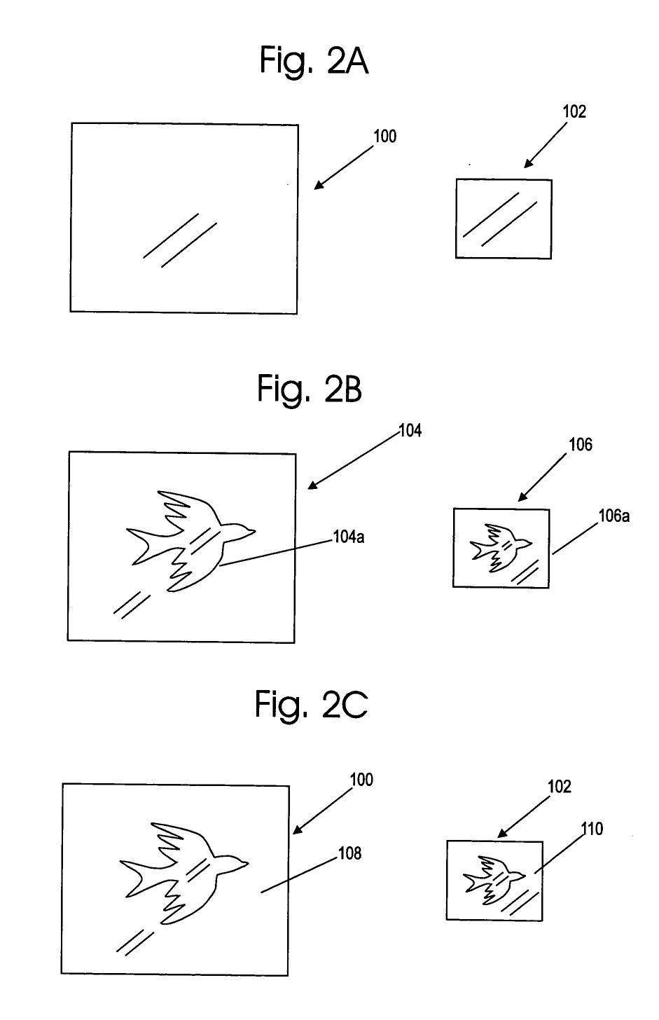

FIG. 2A shows a top view a first towel 100 and a second towel 102 for use with an embodiment of the present invention. The towels 100 and 200 may both be made of terricloth or suede, or velour, or any other cloth material.

FIG. 2B shows a top view of a first template 104 and a second template 106 for use with an embodiment of the present invention. A design 104a of a bird is imprinted on the first template 104. A design 106a of a bird is imprinted on the second template 106.

FIG. 2C shows a top view of the towels 100 and 102 of FIG. 2A after first and second designs, respectively, have been transferred onto the towels 100 and 102. The towel 100 now includes a design 108 which corresponds to the design 104a from the template 104. The towel 102 now includes a design 110 which corresponds to the design 106a from the template 106. The designs may be transferred from the templates 104 and 106 by placing the templates 104 and 106 on top of the towels 100 and 102, respectively, and then ironing the templates 104 and 106 until the designs 108 and 110 are located on the towels 100 and 102, respectively.

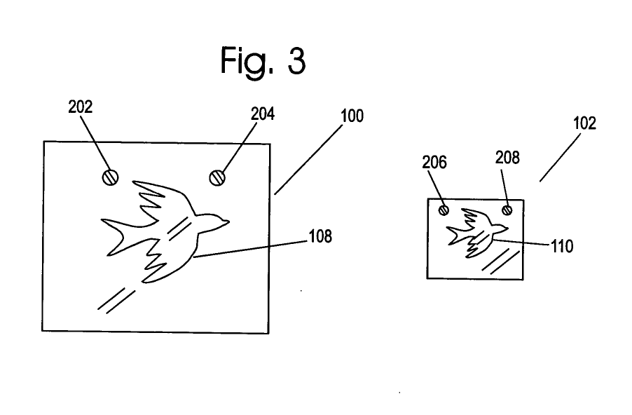

FIG. 3 shows a top view of the towels 100 and 102 with the respective designs 108 and 110 and further including three dimensional objects 202 and 204 mounted on the towel 100 and three dimensional objects 206 and 208 mounted on the towel 102. The three dimensional objects may include lace, rick rack, bias tape, seam binding, cording, sequins, rhinestone, fabric paint (i.e. a type of paint that is used to create designs on fabric or material), artificial flowers, or plastic toy moving eyes, for example,

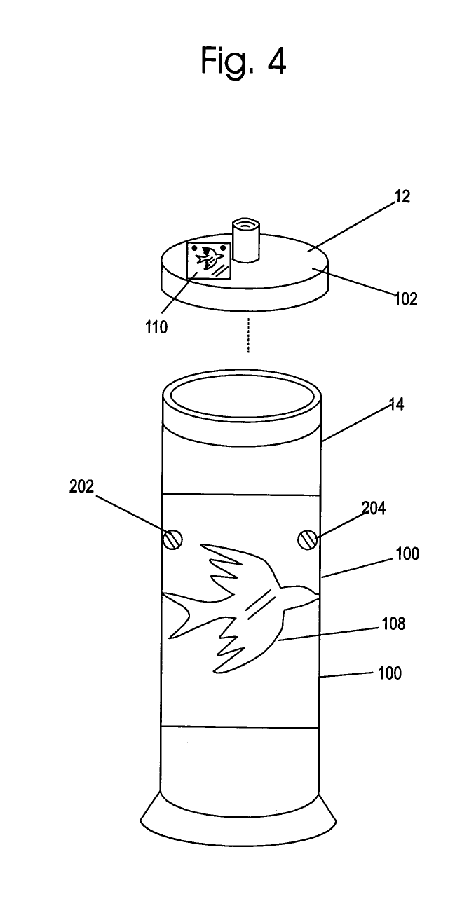

FIG. 4 shows a top perspective view of the apparatus 10 of FIG. 1A with the first towel 100 attached to the body portion 14 of the apparatus 10 and the second towel 102 attached to the lid 12 of the apparatus 10. The first towel 100 may be wrapped around the body portion 14 and attached to the body portion 14 by using a glue gun to glue the first towel 100 to the body portion 14. The second towel 102 may be wrapped around or placed on the lid 12 and attached to the lid 12 by using a glue gun to glue the second towel 102 to the lid 12.

Various items may be placed inside the body portion 14 of the container or apparatus 10, such as stockings, underwear, socks, scarves, hair rollers, toilet tissues, patterns, gloves, craft supplies, quilting pieces, plastic bags etc. The apparatus 10 along with the first towel 100 and second towel 102 and any designs and three dimensional objects, may be small enough to fit inside drawers, bags or can be placed on shelves.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. An apparatus comprising:
a container comprised of a body portion and a lid; and
a first towel wrapped around the body portion.

2. The apparatus of claim 1 wherein
the first towel includes a design.

3. The apparatus of claim 1 further comprising
a second towel attached to the lid portion.

4. The apparatus of claim 3 wherein
the second towel includes a design.

5. The apparatus of claim 2 further comprising
at least one three dimensional object attached to the first towel.

6. The apparatus of claim 4 further comprising
at least one three dimensional object attached to the second towel.

7. The apparatus of claim 1 wherein
the body portion has a cylindrical shape.

8. A method comprising the steps of
placing a first design on a first towel; and
attaching the first towel to a body portion of a container.

9. The method of claim 8 wherein
the first design is placed on the first towel by ironing the first design onto the first towel.

10. The method of claim 8 further comprising
attaching at least one three dimensional object to the first towel.

11. The method of claim 8 wherein
the body portion of the container is cylindrical.

12. The method of claim 8 further comprising
placing a second design on a second towel; and
attaching the second towel to a lid of the container.

13. The method of claim 8 further comprising
attaching at least one three dimensional object to the second towel.

14. The method of claim 12 wherein
the second design is placed on the second towel by ironing the second design onto the second towel.
